(19) United States
(12) Patent Application Publication
(10) Pub. No.: US 2020/0192693 A1
(43) Pub. Date: Jun. 18, 2020

(54) CONTAINER PROVISION SUPPORT SYSTEM AND CONTAINER PROVISION SUPPORT METHOD

(71) Applicant: HITACHI, LTD., Tokyo (JP)

(72) Inventors: Taro KAWASE, Tokyo (JP); Akihisa NAGAMI, Tokyo (JP); Wataru ONO, Tokyo (JP); Yutaro SEINO, Tokyo (JP); Ryosuke KONDO, Tokyo (JP)

(73) Assignee: HITACHI, LTD., Tokyo (JP)

(21) Appl. No.: 16/569,436

(22) Filed: Sep. 12, 2019

(30) Foreign Application Priority Data
Dec. 13, 2018 (JP) 2018-233904

(51) Int. Cl. G06F 9/455; G06F 11/20

(52) U.S. Cl. CPC G06F 9/45558; G06F 11/2094; G06F 2009/45575; G06F 2009/45562; G06F 2009/45583; G06F 2201/815

(57) ABSTRACT

A container provision support system capable of shortening time required to provide a container is provided. A first site is provided with a first registry apparatus including a first container image used to activate a first container that is an environment to execute an application program, a first container apparatus for activating the first container based on the first container image, and a first storage apparatus that provides a first volume to be used in the application program; and a second site is provided with a second storage apparatus that provides a second volume which is replicated data of the first volume; and there is provided a management unit that manages management information which associates identification information of the first volume, identification information of the second volume, and identification information of the first container image with each other.

### TECHNICAL FIELD

The present invention relates to a container provision support system and a container provision support method.

### BACKGROUND ART

In recent years, a container technology has been becoming rapidly widespread with the appearance of Docker (registered trademark) which is open software for providing a container-type virtual environment. With the container technology, a container which is an environment to execute an application program is activated based on a container image which is a file system. In this regard, a technology for managing the container image with a registry (repository) is disclosed (see PTL 1).

### CITATION LIST

### Patent Literature

PTL 1: Japanese Patent Application Laid-Open (Kokai) Publication No. 2017-219972

### SUMMARY OF THE INVENTION

### Problems to be Solved by the Invention

Under this circumstance, for example, if a failure occurs when using the container at a main site (local site), business will be continued by switching to a DR (Disaster Recovery) site (remote site). However, the problem is that it requires time to identify a container image which is required to activate the container at the DR site and a volume to be used in an application program executed on the relevant container and it thereby requires time to provide the container at the DR site.

The present invention was devised in consideration of the above-described circumstances and aims at proposing a container provision support system capable of shortening the time required to provide the container.

### Means to Solve the Problems

In order to solve the above-described problems according to the present invention, a first site is provided with a first registry apparatus including a first container image used to activate a first container that is an environment to execute an application program, a first container apparatus for activating the first container based on the first container image, and a first storage apparatus that provides a first volume to be used in the application program; and a second site is provided with a second storage apparatus that provides a second volume which is replicated data of the first volume; and there is provided a management unit that manages management information which associates identification information of the first volume, identification information of the second volume, and identification information of the first container image with each other.

According to the above-described configuration, for example, if a failure occurs at the first site, the container image required to activate the container at the second site is linked, by the management information, to the second volume to be used by the application program executed on the relevant container. So, the container image and the volume which are required to activate the container can be easily identified and the container can be activated at the second site in a short time.

### Advantageous Effects of the Invention

A highly reliable system can be implemented according to the present invention. Incidentally, any problems, configurations, and advantageous effects other than those described above will be made clear by the description of embodiments below.

### BRIEF DESCRIPTION OF DRAWINGS

FIG. 1 is a diagram illustrating an example of the configuration of a container provision support system according to a first embodiment;

FIG. 2 is a diagram illustrating an example of a physical configuration of the container provision support system according to the first embodiment;

FIG. 3 is a diagram illustrating an example of a logical configuration of the container provision support system according to the first embodiment;

FIG. 4 is a diagram illustrating an example of a site-storage management table according to the first embodiment;

FIG. 5 is a diagram illustrating an example of a site-registry management table according to the first embodiment;

FIG. 6 is a diagram illustrating an example of a registry-image management table according to the first embodiment;

FIG. 7 is a diagram illustrating an example of a volume-image management table according to the first embodiment;

FIG. 8 is a diagram illustrating an example of a replication management table according to the first embodiment;

FIG. 9 is a diagram illustrating an example of processing upon container startup according to the first embodiment;

FIG. 10 is a diagram illustrating an example of the processing upon container startup according to the first embodiment;

FIG. 11 is a diagram illustrating an example of the processing upon container startup according to the first embodiment;

FIG. 12 is a diagram illustrating an example of the processing upon container startup according to the first embodiment;

FIG. 13 is a diagram illustrating an example of processing upon container image update according to the first embodiment;

FIG. 14 is a diagram illustrating an example of processing upon failover according to the first embodiment;

FIG. 15 is a diagram illustrating an example of the configuration of a container provision support system according to a second embodiment; and

FIG. 16 is a diagram illustrating an example of a container provision support system according to a third embodiment.

### DESCRIPTION OF EMBODIMENTS

An embodiment of the present invention will be described below in detail with reference to the drawings.

Incidentally, when elements of the same type are explained in the following description without distinguishing them from each other, a common part (part excluding a branch number) of reference numerals including branch numbers will be used; and when the elements of the same type are explained by distinguishing them from each other, the reference numerals with the branch numbers may sometimes be used. For example, when sites are explained without particularly distinguishing them from each other, they may be described as “site(s) 101”; and when the sites are explained by distinguishing the individuals sites from each other, they may sometimes be described as “site 101-1,” “site 101-2,” and so on.

### (1) First Embodiment

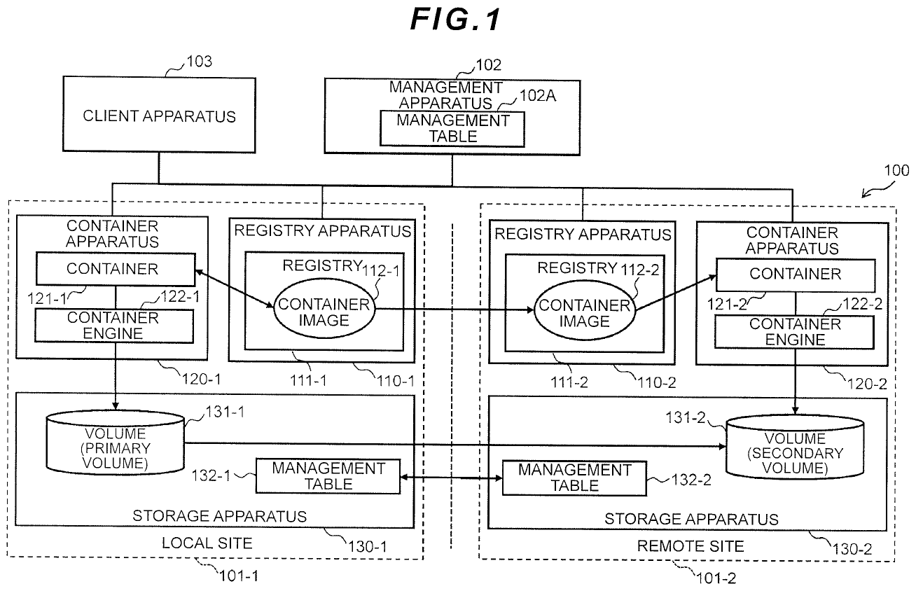

Referring to FIG. 1, the reference numeral 100 generally represents a container provision support system according to a first embodiment.

A container provision support system 100 is configured by including one or more sites 101, one or more management apparatuses 102, and one or more client apparatuses 103. In this embodiment, an explanation will be provided by taking examples of a first site 101-1 (a local site which is the site of an active system) and a second site 101-2 (a remote site which is the site of a standby system) as the sites 101. Incidentally, the container provision support system 100 may include or not include the site(s) 101. Furthermore, the container provision support system 100 may include or not the client apparatus(es) 103.

The site 101 is, for example, a data center to handle data relating to business and is configured by including one or more registry apparatuses 110, one or more container apparatuses 120, and one or more storage apparatuses 130.

The registry apparatus 110 may be a server apparatus which provides a storage space called a registry 111. A container image 112 is registered in the registry 111. The container image 112 is a file system which is required to activate a container 121 described later (a file group which is required to operate the container 121). Additionally, the container image 112 is, for example, a set of read-only layers; and a first layer is called a base image and all other layers are stacked on the layer of the base image. A layer includes, for example, a file system and meta data (management information indicating what command to be executed, which port to be opened, and so on).

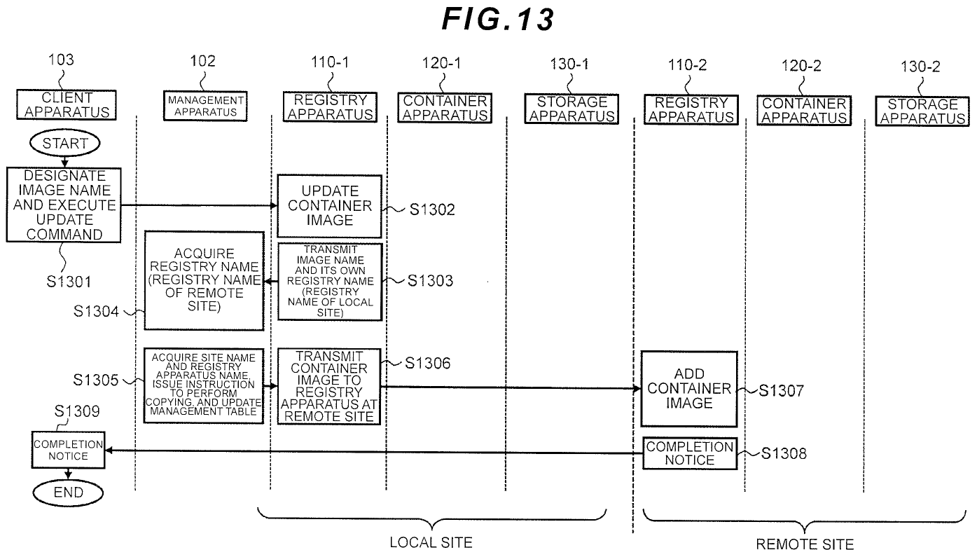

Under this circumstance, as described later with reference to FIG. 13, for example, a client apparatus 103 may sometimes transmit a command to the registry apparatus 110 to change (for example, register, update, or delete) the container image 112 and the container image 112 of the registry apparatus 110 may be changed. A management apparatus 102 detects the change of the container image 112 with respect to the registry apparatus 110; however, there is no limitation on how to detect it. For example, the change of the container image 112 may be detected as a result of monitoring by the management apparatus 102. Furthermore, for example, regarding the change of the container image 112, the registry apparatus 110 may be set in advance so that a notice will be issued to the management apparatus 102 when the container image 112 is changed in the registry apparatus 110; and the registry apparatus 110 may inform the management apparatus 102 of the change according to the above-described setting and the change of the container image 112 may be detected.

The container apparatus 120 includes a container engine 122 to activate (generate) a container 121. The container 121 is an environment to execute an APP (application program) relating to the business and includes, for example, everything required to execute the APP. The container 121 is what is generated, started, stopped, moved, and/or deleted by the container engine 122. To generate the container 121 herein means, for example, to add a readable/writable layer to the container image 112 and execute it in a state where a designated process is isolated, for example, on a system resource.

If the container apparatus 120 has no container image 112 (for example, upon first execution) when activating the container 121, the container engine 122 acquires (downloads) the container image 112 from the registry apparatus 110. Incidentally, one or more containers 121 may be generated at the container engine 122 and one or more containers 121 may be operable in the container apparatus 120.

The container engine 122 can generate (change) the container image 112. When this happens, there are a case of manually making the change and a case of automatically making the change. In either case, a change command is transmitted from the client apparatus 103 to the container engine 122; and when the container engine 122 receives the change command, it changes the container image 112 and issues a notice to the management apparatus 102 to inform it of the change of the container image 112 (such as an image name of the container image 112). The management apparatus 102 can recognize the change of the container image 112 through the notice. Furthermore, the container engine 122 may be configured to transmit the changed container image 112 to the registry apparatus 110.

The storage apparatus 130 provides a volume 131, which is to be used when executing the APP, to the container 121 which executes the APP on the container engine 122. For example, with a storage apparatus 130-1 at the local site, a volume 131-1 (primary volume) to be used when executing the APP is linked to a container 121-1 for executing the APP on a container engine 122-1. Furthermore, for example, a storage apparatus 130-2 at the remote site is provided with a volume 131-2 (secondary volume) which is a replica (replicated data) of the volume 131-1 (primary volume). Incidentally, the volume 131-2 (secondary volume) is provided for a container 121-2 for executing the APP on a container engine 122-2 and is used upon execution of the APP.

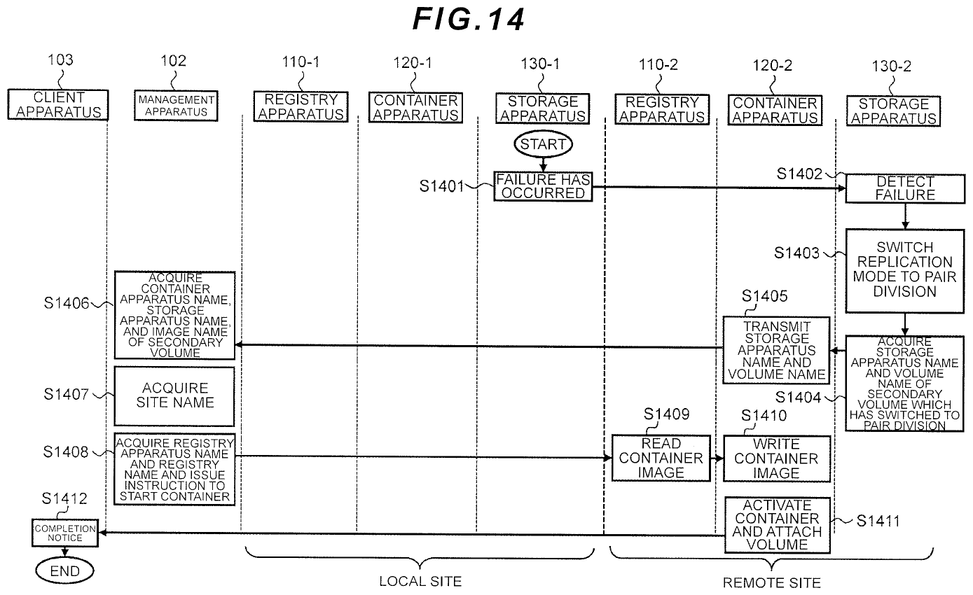

Furthermore, when a failure (a failure when using the container 121-1 such as a system failure or a network failure) has occurred at the local site, a container apparatus 120-2 at the remote site may start the container 121-2 based on a container image 112-2 and link the container 121-2 to the volume 131-2. By starting the container 121-2 and linking it to the volume 131-2 when the failure has occurred, it is possible to switch to the remote site. For example, the container 121-2 may be made available as triggered by pair division of the replication (this case will be described later with reference to FIG. 14). Furthermore, the container 121-2 may be made available as triggered by, for example, detection of hang-up or infinite loop of the APP. Furthermore, the container 121-2 may be made available as triggered by, for example, detection of a communication error.

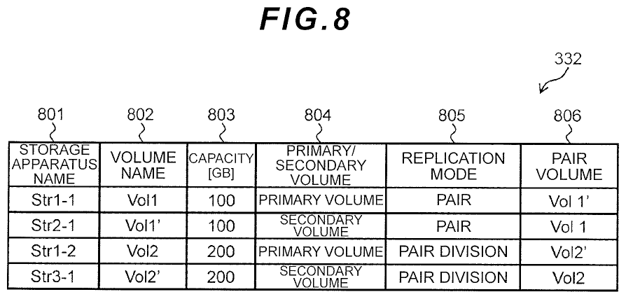

Furthermore, the storage apparatus 130 includes a management table 132 which stores information relating to the replication between the primary volume and the secondary volume. Incidentally, the management table 132 will be explained later with reference to FIG. 8.

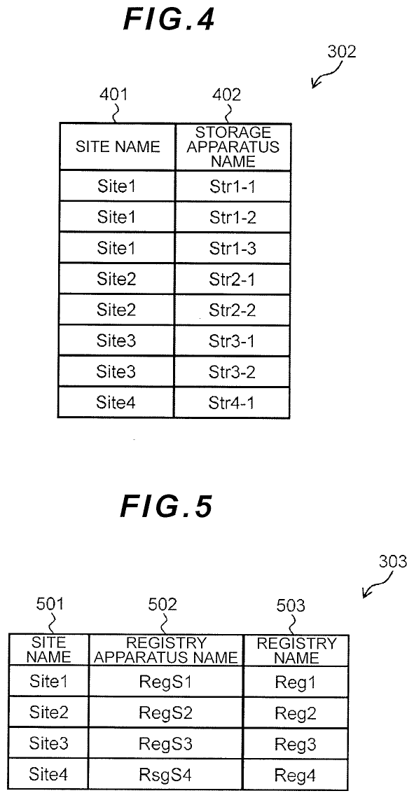

The management apparatus 102 includes one or more management tables 102A which store information relating to the construction of the container 121. The management table 102A retains, for example, the correspondence relationship between the container image 112, the primary volume, and the secondary volume. Incidentally, the management table 102A will be explained later with reference to FIG. 4 to FIG. 7.

The management apparatus 102 manages, for example, management information (for example, a volume-image management table 305 described later) which associates the following information with each other: identification information of the first volume (for example, a container apparatus name of the container apparatus 120-1 relating to the volume 131-1, a storage apparatus name of the storage apparatus 130-1 which provides the volume 131-1, and a volume name of the volume 131-1); identification information of the second volume (for example, the container apparatus name of the container apparatus 120-2 relating to the volume 131-2, the storage apparatus name of the storage apparatus 130-2 which provides the volume 131-2, and the volume name of the volume 131-2); and identification information of the first container image (for example, an image name of the container image 112-1; however, it should be noted that since the container image 112-1 and the container image 112-2 have the same image name, the identification information of the first container image may also be the image name of the container image 112-2).

Incidentally, the management information may be automatically generated as described later, for example, when starting the container 121, or may be manually generated by an administrator. In either case, the container image 112-2 which is required to activate the container 121-2 at the remote site is linked, by the management information, to the volume 131-2 to be used in the APP executed on the container 121-2. Accordingly, the container image 112-2, which is required to activate the container 121-2, and the volume 131-2 can be easily identified, so that the container 121-2 can be activated at the remote site in a short time when switching from the local site to the remote site. Additionally, by causing the management information to be generated automatically, it is possible to avoid the administrator's work to register a volume corresponding to the container image 112, which is required when activating the container 121-2 at the remote site, in a register.

The management apparatus 102 may perform copying of the container image 112-1 to the registry apparatus 110-2 at the remote site along with the creation of the secondary volume at the remote site on the basis of the management table 102A. Incidentally, the container image 112-1 may be copied by the administrator's operation of the client apparatus 103. Specifically speaking, it is preferable that the registry apparatus 110-2 including the container image 112-2 which is the replicated data of the container image 112-1, and the container apparatus 120-2 for activating the container 121-2 based on the container image 112-2 be provided at the remote site. Accordingly, even if the situation takes place where the container image 112-1 cannot be acquired upon the occurrence of a failure at the local site, it is possible to avoid the circumstance where the container 121-2 cannot be activated at the remote site and it becomes no longer possible to continue the business at the remote site, by registering the copy of the container image 112 in the registry apparatus 110-2 at the remote site. Additionally, for example, when the volume 131-2 is created, the management apparatus 102 may replicate the container image 112-1 as the container image 112-2 in the registry apparatus 110-2. According to the above-described configuration, it is possible to reduce the administrator's burden with respect to copying of the container image 112-1.

The client apparatus 103 is an apparatus which transmits a command to issue an instruction to start the container 121, a command to issue an instruction to activate the container 121, a command to issue an instruction to update the container image 112, and so on to the registry apparatus 110, the container apparatus 120, etc., and is an apparatus for operating the APP relating to the business.

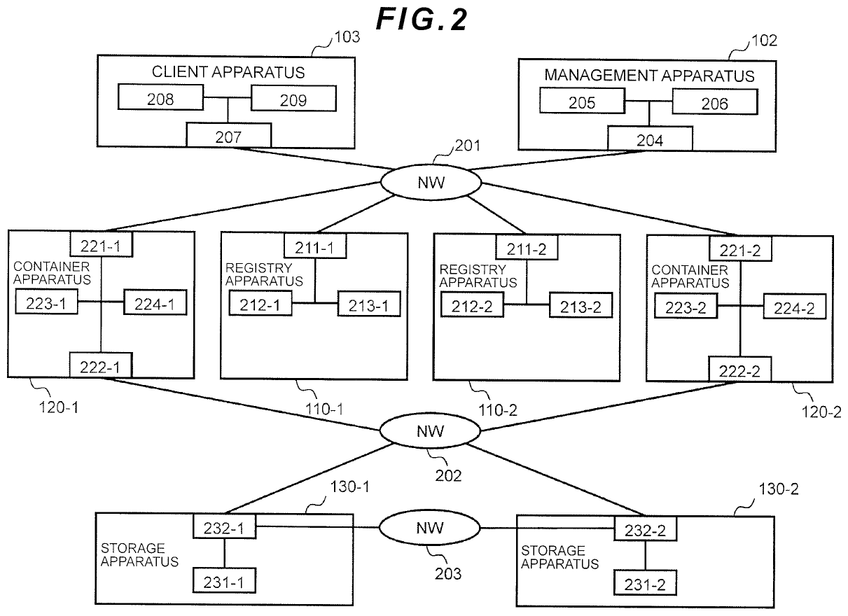

FIG. 2 is a diagram illustrating an example of a physical configuration relating to the container provision support system 100.

The management apparatus 102, the client apparatus 103, the registry apparatuses 110, and the container apparatuses 120 are coupled to a LAN (Local Area Network) 201 which is an example of a first network. Each container apparatus 120 and each storage apparatus 130 are coupled to an FC (Fibre Channel) network 202 which is an example of a second network. Each storage apparatus 130 is coupled to an FC network 203 which is an example of a third network.

The FC network 202 is an example of a front-end network of each storage apparatus 130. The FC network 203 is an example of a back-end network of each storage apparatus 130. Incidentally, two or more networks of the first network to the third network may be integrated. Regarding the networks, other types of networks such as a WAN (Wide Area Network) may be adopted.

The management apparatus 102 includes a LAN interface 204 coupled to the LAN 201, a storage unit 205, and a processor unit 206 coupled to them.

Functions of the management apparatus 102 (such as a management unit 301 described later) may be implemented, for example, by the processor unit 206 reading a program to the storage unit 205 and executing it (software), by hardware such as a dedicated circuit, or by a combination of the software and the hardware. Furthermore, some of the functions of the management apparatus 102 may be implemented by another computer which is capable of communicating with the management apparatus 102.

The client apparatus 103 includes a LAN interface 207 coupled to the LAN 201, a storage unit 208, and a processor unit 209 coupled to them.

Functions of the client apparatus 103 (such as a client unit 306 described later) may be implemented, for example, by the processor unit 209 reading a program to the storage unit 208 and executing it (software), by hardware such as a dedicated circuit, or by a combination of the software and the hardware. Furthermore, some of the functions of the client apparatus 103 may be implemented by another computer which is capable of communicating with the client apparatus 103.

The registry apparatus 110 includes a LAN interface 211 coupled to the LAN 201, a storage unit 212, and a processor unit 213 coupled to them.

The container apparatus 120 includes an interface unit (a LAN interface 221 coupled to the LAN 201 and an FC interface 222 coupled to the FC network 202), a storage unit 223, and a processor unit 224 coupled to them.

The storage apparatus 130 includes a PDEV unit 231 and a storage controller 232 coupled to the PDEV unit 231. The storage controller 232 is coupled to the FC network 202 and the FC network 203. The storage controller 232 includes an interface unit, a memory unit, and a processor unit coupled to them (although they are omitted in the drawing). The storage controller 232 receives an I/O (Input/Output) request output from the container apparatus 120 in accordance with the execution of the APP and performs I/O on the volume 131 in response to the I/O request. Data to be written to the volume 131 is written to a physical storage area (a storage area in the PDEV unit 231) associated with a logical storage area in the volume 131.

Incidentally, each apparatus of the management apparatus 102, the client apparatus 103, the registry apparatus 110, the container apparatus 120, and the storage apparatus 130 may include, for example, an input unit such as a keyboard and a pointing device, an output unit such as a display and a speaker, and an input/output device such as a touch panel. Furthermore, the input unit, the output unit, and the input/output unit may be coupled to each apparatus 102.

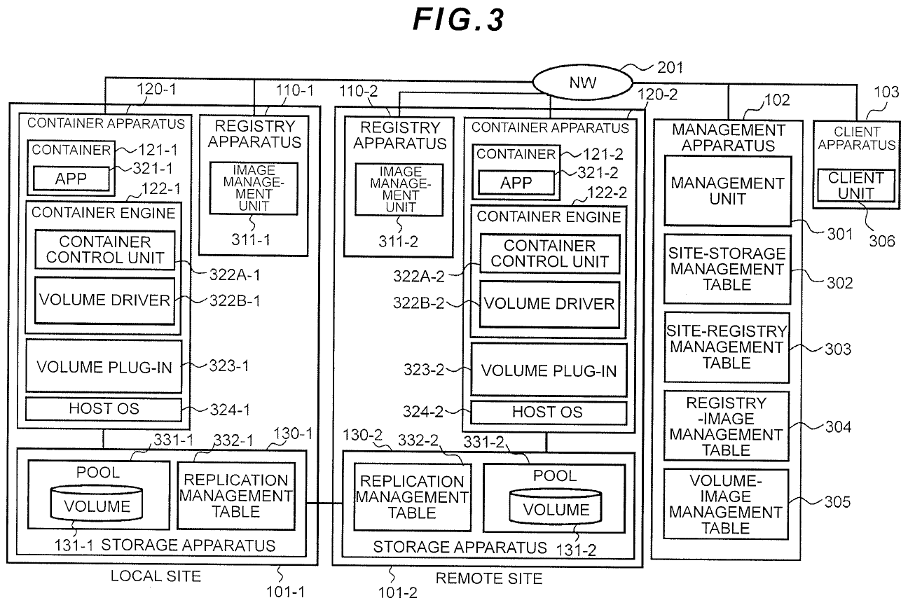

FIG. 3 is a diagram illustrating an example of a logical configuration relating to the container provision support system 100.

The management apparatus 102 includes the management unit 301. The management unit 301 manages, for example, the management table 102A (a site-storage management table 302, a site-registry management table 303, a registry-image management table 304, and a volume-image management table 305).

The management unit 301 may generate the management information for activating the container 121-2 at the remote site. For example, when receiving a request to start the container 121-1 by designating the volume 131-1 from the client apparatus 103, the management unit 301 issues an instruction to the storage apparatus 130-2 to create the volume 131-2, acquires the identification information of the volume 131-2 created by the storage apparatus 130-2, and generates the management information by associating the identification information of the volume 131-1 designated by the above-mentioned request, the identification information of the volume 131-2 acquired from the storage apparatus 130-2, and the identification information of the container image 112-1 used to activate the container 121-1 with each other.

Furthermore, the management unit 301 may manage the container image 112-1 for activating the container 121-2 at the remote site. For example, the management unit 301 replicates the container image 112-1 as the container image 112-2 in the registry apparatus 110-2. Furthermore, for example, when the management unit 301 receives a notice transmitted in response to the registration of the container image 112 in the registry apparatus 110 and judges that the container image 112-2 has been updated, it transmits the updated container image 112-1 to the registry apparatus 110-2. Incidentally, the management unit 301 may monitor the container 121. Incidentally, if a failure occurs at the container 121 as a result, there is a case where that failure may be detected.

Furthermore, the management unit 301 may integrate two or more container images 112 to form one container image 112 or execute other processing.

The client apparatus 103 includes a client unit 306. The client unit 306, for example, issues an instruction to the management apparatus 102 to start the container 121-1 at the local site. Furthermore, for example, the client unit 306 issues an instruction to the registry apparatus 110-1 to change the downloaded container image 112-1.

The registry apparatus 110 includes an image management unit 311. The image management unit 311, for example, transmits the container image 112 in response to a request from the container engine 122. Furthermore, for example, the image management unit 311 transmits a notice to the management apparatus 102 in response to the change of the container image 112.

Furthermore, for example, the image management unit 311 creates a copy of the container image 112 at another registry apparatus 110 in response to the instruction from the management apparatus 102. For example, when receiving the instruction from the management apparatus 102 to copy the image 112-1 of the registry apparatus 110-2, the image management unit 311-1 transmits the container image 112-1 to the registry apparatus 110-2. The image management unit 311-2 for the registry apparatus 110-2 registers the received container image 112-1 as the container image 112-2.

With the container apparatus 120, the storage unit 223 stores programs such as the container engine 122 which is configured by including a container control unit 322A and a volume driver 322B, a volume plug-in 323, and a host OS (Operating System) 324; and these programs are executed by the processor unit 224.

The container control unit 322A performs, for example, activation of the container 121 and creation of the container image 112 of the container 121. Incidentally, an APP 321 is operable on the activated container 121.

The volume driver 322B receives a notice from the container control unit 322A to activate the container 121 and issues an instruction to the volume plug-in 323 to link the volume 131. The volume plug-in 323 links the volume 131 to the target container 121 to be activated in response to the instruction and then that container 121 is activated. Incidentally, information indicating the correspondence relationship between the container 121 and the volume 131 may be managed by the management table 132, or may be embedded in and managed by the container image 112, or may be managed by another storage area. Furthermore, the volume driver 322B updates a replication management table 332 (an example of the management table 132) in the storage apparatus 130.

The volume plug-in 323 performs volume control by, for example, setting virtual storage in response to a virtual storage setting instruction. For example, the volume plug-in 323, for example, transmits an instruction to the storage apparatus 130 to create a secondary volume by setting a certain volume 131 as a primary volume. In response to that instruction, for example, a volume 131-2 which is replicated data of a volume 131-1 is created. Furthermore, for example, the volume plug-in 323 links the volumes 131 provided from the storage apparatus 130 to the container 121. Furthermore, for example, the volume plug-in 323 sets the virtual storage setting in response to the virtual storage setting instruction.

The host OS 324 is a kernel that provides a basic environment for the container control unit 322A, the volume driver 322B, the volume plug-in 323, etc. to operate.

The storage apparatus 130 includes a pool 331 and a replication management table 332. The storage apparatus 130, for example, cuts out a volume(s) 131 from the pool 331 and provides it.

The pool 331 stores, for example, data which is the difference between volumes 131 (for example, data for snapshot volumes). For example, if the volumes 131 are volumes according to Thin Provisioning, the pool 331 may be a pool including storage areas which are dynamically allocated to the volumes 131. Incidentally, the pool 331 may be provided, or may not be provided, across a plurality of storage apparatuses 130.

The replication management table 332 may be stored in the memory unit for the storage controller 232 or in a specified volume 131. Incidentally, the replication management table 332 will be explained later with reference to FIG. 8.

Incidentally, in this embodiment, the replication management table 332 of the same content is retained in all the storage apparatuses 130. In other words, the replication management table 332 is synchronized in the storage apparatuses 130.

FIG. 4 is a diagram illustrating an example of the site-storage management table 302.

The site-storage management table 302 retains information indicating the relationship between the sites 101 and the storage apparatuses 130. More specifically, the site-storage management table 302 includes information capable of identifying the storage apparatuses 130 provided at each site 101. For example, the site-storage management table 302 stores information which associates a site name 401 with a storage apparatus name 402. The site name 401 indicates identification information capable of identifying the site 101. The storage apparatus name 402 indicates identification information capable of identifying the storage apparatus 130.

FIG. 5 is a diagram illustrating an example of the site-registry management table 303.

The site-registry management table 303 retains information indicating the relationship between the registry apparatus 110 and the registry 111 at each site 101. More specifically, the site-registry management table 303 includes information capable of identifying the registry 111 provided each site 101. For example, the site-registry management table 303 stores information which associates a site name 501, a registry apparatus name 502, and a registry name 503 with each other. The site name 501 indicates identification information capable of identifying the site 101. The registry apparatus name 502 indicates identification information capable of identifying the registry apparatus 110. The registry name 503 indicates identification information capable of identifying the registry 111.

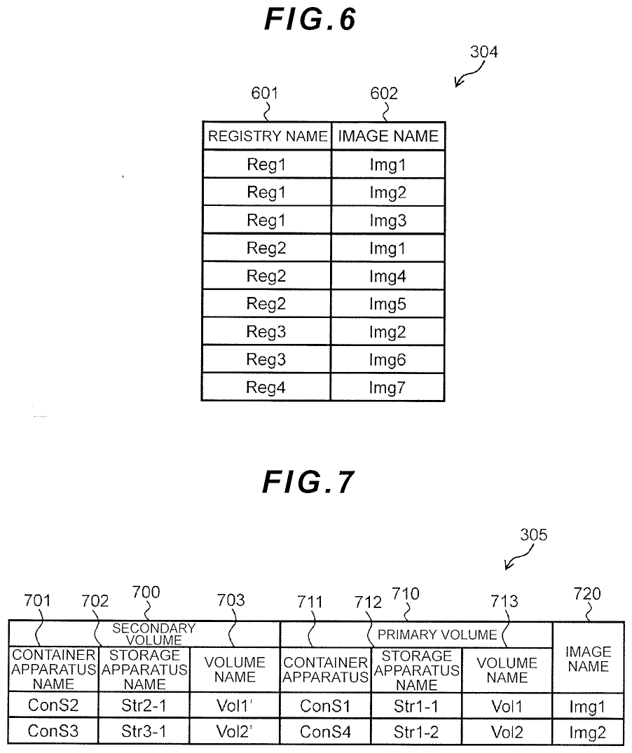

FIG. 6 is a diagram illustrating an example of the registry-image management table 304.

The registry-image management table 304 retains information indicating the relationship between the registries 111 and the container images 112. More specifically, the registry-image management table 304 includes information capable of identifying the container image 112 stored at each registry 111. For example, the registry-image management table 304 stores information which associates a registry name 601 with an image name 602. The registry name 601 indicates identification information capable of identifying the registry 111. The image name 602 indicates identification information capable of identifying the container image 112.

FIG. 7 is a diagram illustrating an example of the volume-image management table 305.

The volume-image management table 305 retains information indicating the relationship between the secondary volume, the primary volume, and the container image 112. More specifically, the volume-image management table 305 includes information capable of identifying the container image 112 corresponding to a pair of the secondary volume and the primary volume. For example, the volume-image management table 305 stores information which associates the secondary volume 700, the primary volume 710, and the image name 720 with each other.

The secondary volume 700 indicates information relating to the secondary volume (the volume 131-2). For example, the secondary volume 700 stores information which associates a container apparatus name 701, a storage apparatus name 702, and a volume name 703 with each other. The container apparatus name 701 indicates identification information capable of identifying the container apparatus 120 which links the secondary volume to the container 121. The storage apparatus name 702 indicates identification information capable of identifying the storage apparatus 130 which provides the secondary volume. The volume name 703 indicates identification information capable of identifying the secondary volume.

The primary volume 710 indicates information relating to the primary volume (the volume 131-1). For example, the primary volume 710 stores information which associates a container apparatus name 711, a storage apparatus name 712, and a volume name 713 with each other. The container apparatus name 711 indicates identification information capable of identifying the container apparatus 120 which links the primary volume to the container 121. The storage apparatus name 712 indicates identification information capable of identifying the storage apparatus 130 which provides the primary volume. The volume name 713 indicates identification information capable of identifying the primary volume.

The image name 720 indicates identification information capable of identifying the container image 112 used to activate the container apparatus 120 which is linked to the secondary volume (it should be noted that when the container image 112-1 and the container image 112-2 have the same image name, this may be the primary volume).

Additionally, the information of the secondary volume and the information of the primary volume may include identification information capable of identifying the pool such as a pool name or may include identification information capable of identifying the container 121 such as a container name.

FIG. 8 is a diagram illustrating an example of the replication management table 332.

The replication management table 332 retains information for managing the replication of the volumes 131. More specifically, the replication management table 332 includes information indicating the correspondence relationship between the primary volume and the secondary volume, and a replication status of the primary volume and the secondary volume. For example, the replication management table 332 stores information which associates a storage apparatus name 801, a volume name 802, a capacity 803, a primary/secondary volume 804, a replication mode 805, and a pair volume 806 with each other.

The storage apparatus name 801 indicates identification information capable of identifying the storage apparatus 130. The volume name 802 indicates identification information capable of identifying the volume 131. The capacity 803 indicates the capacity of the volume 131. The primary/secondary volume 804 indicates the type of the volume 131 (the primary volume or the secondary volume) as identified by the volume name 802. The replication mode 805 indicates a replication mode (“Pair” indicating that the volumes are synchronized or “Pair Division” indicating that the volumes are not synchronized). The pair volume 806 indicates a volume 131 which constitutes a pair with the volume 131 identified by the volume name 802.

Next, container provision support processing at the container provision support system 100 will be explained.

The container provision support processing may be configured by including, for example, processing upon starting the container 121 at the local site ((A) processing upon container startup, processing executed when the container image 112 is updated ((B) processing upon container image update), and processing executed when automatically switching to the remote site upon the occurrence of a failure at the local site ((C) processing upon failover). An example of the container provision support processing will be explained below.

### (A) Processing Upon Container Startup

Examples of main processing of the processing upon container startup include the following processing (A-1) to (A-4).

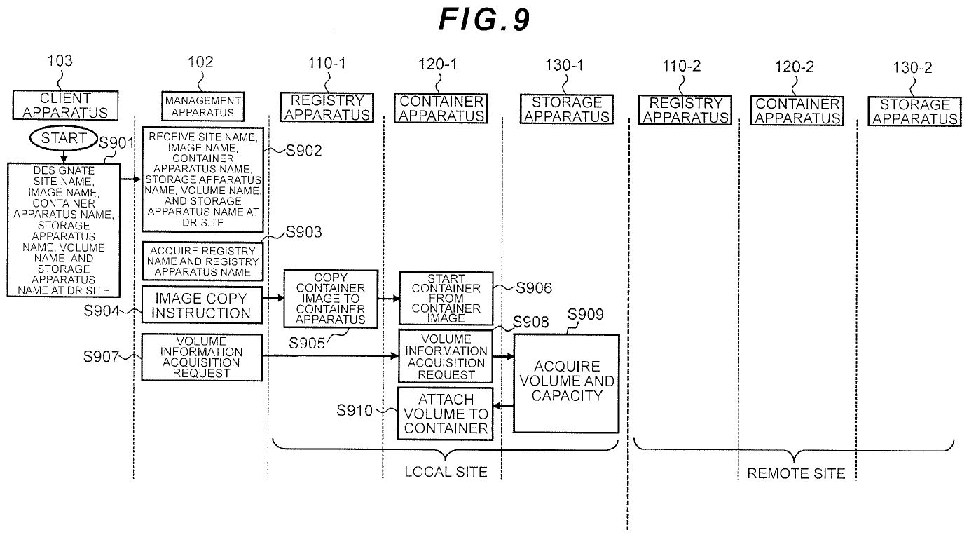

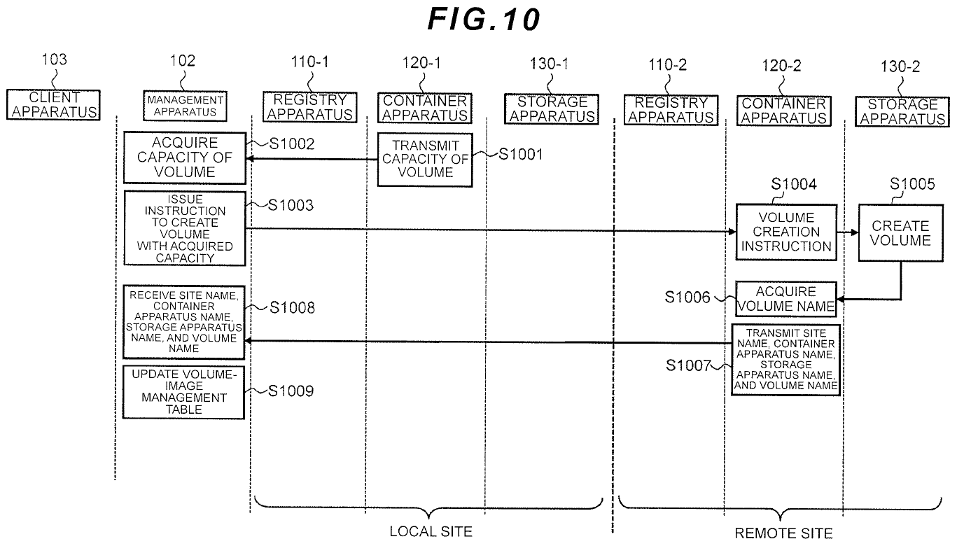

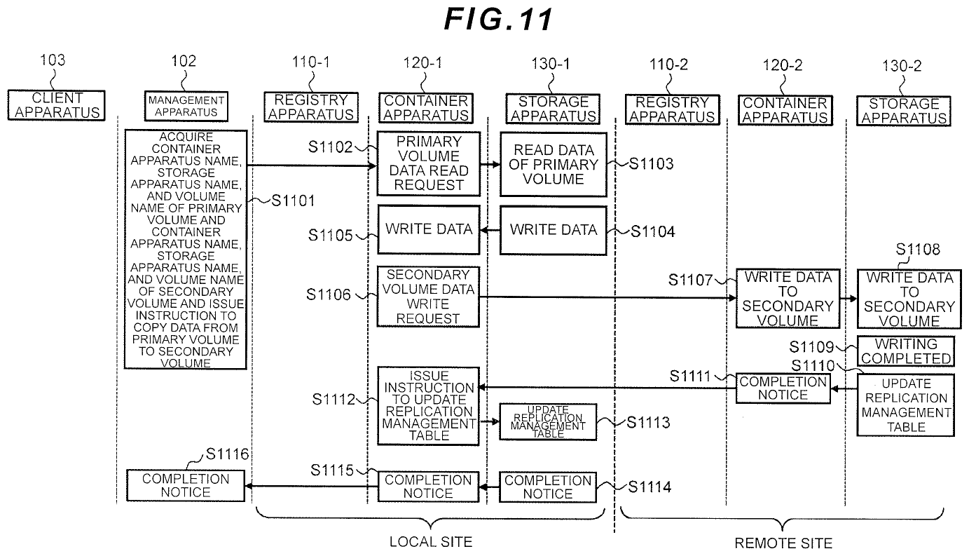

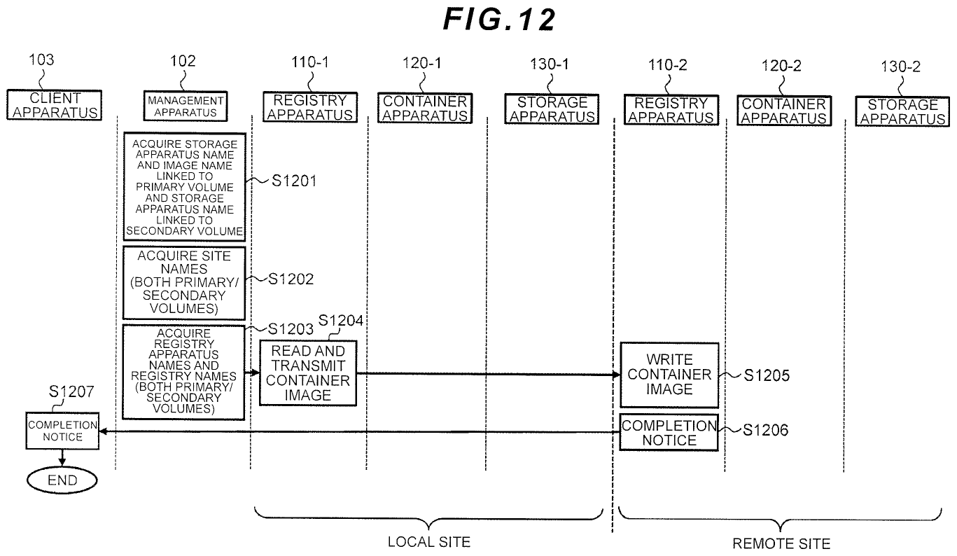

(A-1) Startup of the container 121 at the local site (FIG. 9)
(A-2) Creation of the volume 131 at the remote site (FIG. 10)
(A-3) Setting of replication (FIG. 11)
(A-4) Creation of a copy of the container image 112 in the registry 111 at the remote site (FIG. 12)
(B) Processing Upon Container Image Update A copy of the updated container image 112 is created at the remote site (FIG. 13).

### (C) Processing Upon Failover

When a failure has occurred at the local site, the container 121 is started at the remote site (FIG. 14).

### (A) Processing Upon Container Startup

### (A-1) Startup of the Container 121 at the Local Site

FIG. 9 is a diagram illustrating an example of the processing relating to the startup of the container 121 at the local site.

In step S901, the client apparatus 103 transmits an instruction to the management apparatus 102 to start the container 121. The client apparatus 103 issues the instruction to the management apparatus 102 to start the container 121 by designating, for example, the site name of the local site which has been input by the administrator, the image name of the container image 112 used to start the container 121, the container apparatus name of the container apparatus 120 which stores the container image 112, the storage apparatus name of the storage apparatus 130 which provides the volume 131 linked to the container 121, the volume name of the volume 131 linked to the container 121, and the storage apparatus name of the storage apparatus 130 at the DR site (the remote site) which provides the replicated data (the secondary volume) of the volume 131 linked to the container 121. Incidentally, information included in the instruction to start the container 121 is not limited to the above-described information. For example, the storage apparatus name at the DR site may not be included.

An explanation will be provided below as appropriate by assuming that the site name “Site1” of the site 101, the image name “img1” of the container image 112-1, the container apparatus name “ConS1” of the container apparatus 120-1, the storage apparatus name “Str1-1” of the storage apparatus 130-1, the volume name “Vol1” of the volume 131-1, and the storage apparatus name “Str2-1” of the storage apparatus 130-2 at the DR site are designated.

In step S902, the management apparatus 102 receives the instruction to start the container 121 (the site name, the image name, the container apparatus name, the storage apparatus name, the volume name, and the storage apparatus name at the DR site).

In step S903, the management apparatus 102 acquires (identifies) the registry name and the registry apparatus name which are associated with the relevant site name from the site-registry management table 303 by using the received site name as a key. In this example, the registry apparatus name “RegS1” of the registry apparatus 110-1 and the registry name “Reg1” of the registry 111-1 are identified.

In step S904, the management apparatus 102 transmits an instruction (image copying instruction) to the registry apparatus 110-1 with the identified registry name to transmit the container image 112-1 with the received image name (the target container image 112) to the container apparatus 120-1 with the received container apparatus name.

In step S905, the registry apparatus 110-1 copies (transmits) the container image 112-1 to the container apparatus 120-1.

In step S906, the container apparatus 120-1 starts the container 121-1 from the received container image 112-1.

In step S907, the management apparatus 102 transmits a request to the container apparatus 120-1, in which the container 121-1 is started, to acquire information about the volume 131-1 (target volume) associated with the startup target container 121-1. Incidentally, the acquisition request includes the information of the storage apparatus name and the volume name which were received in step S902.

In step S908, the container apparatus 120-1 transmits a target volume information acquisition request to the storage apparatus 130-1 with the storage apparatus name included in the acquisition request.

In step S909, the storage apparatus 130-1 acquires the volume 131-1 and the capacity (the capacity of the volume 131-2 created at the remote site) from the volume name included in the acquisition request and transmits the acquired volume 131-1 and capacity to the container apparatus 120-1.

In step S910, the container apparatus 120-1 links (attaches) the volume 131-1 to the container 121-1.

### (A-2) Creation of the Volume 131 at the Remote Site

FIG. 10 is a diagram illustrating an example of the processing relating to the creation of the volume 131 at the remote site.

In step S1001, the container apparatus 120-1 transmits the capacity received in step S910 (the capacity of the target volume) to the management apparatus 102.

In step S1002, the management apparatus 102 acquires the capacity of the target volume.

In step S1003, the management apparatus 102 transmits an instruction to the container apparatus 120-2 at the remote site, which is identified by using the site-storage management table 302, to create the volume 131-2 with the acquired capacity in the storage apparatus 130-2 with the storage apparatus name at the DR site received in step S902.

In step S1004, the container apparatus 120-2 transmits an instruction to the storage apparatus 130-2 to create the volume 131-2 with the capacity on which the instruction was given.

In step S1005, the storage apparatus 130-2 creates the volume 131-2 and transmits the volume name of the volume 131-2 created in the container apparatus 120-2.

In step S1006, the container apparatus 120-2 acquires (receives) the volume name.

In step S1007, the container apparatus 120-2 transmits the information of the secondary volume (the site name of the remote site, the container apparatus name, the storage apparatus name, and the volume name) to the management apparatus 102. An explanation will be provided below as appropriate by assuming that the container apparatus 120-2 transmits the site name “Site2” of the remote site, the container apparatus name “ConS2,” the storage apparatus name “Str2-1,” and the volume name “Vol1” to the management apparatus 102.

In step S1008, the management apparatus 102 acquires (receives) the site name of the remote site, the container apparatus name, the storage apparatus name, and the volume name.

In step S1009, the management apparatus 102 updates the volume-image management table 305. More specifically, the management apparatus 102 adds a record including the information of the secondary volume (the site name, the container apparatus name, the storage apparatus name, and the volume name which were acquired in step S1008), the information of the primary volume (the site name, the container apparatus name, the storage apparatus name, and the volume name which were received in step S902), and the information of the image name received in step S902 to the volume-image management table 305.

Incidentally, the management apparatus 102 may output the information of the added record. Regarding an output method, for example, the information may be displayed on the client apparatus 103, transmitted to a specified e-mail address, or printed by a printer on a specified medium, or other output methods may be employed.

### (A-3) Setting of Replication

FIG. 11 is a diagram illustrating an example of the processing relating to the setting of replication.

In step S1101, the management apparatus 102 reads the record added in step S1009 from the volume-image management table 305 as the information of the primary volume which is a replication target (target primary volume) and the information of the secondary volume which is a replication target (target secondary volume). More specifically, the management apparatus 102 acquires the container apparatus name, the storage apparatus name, and the volume name of the target primary volume and the container apparatus name, the storage apparatus name, and the volume name of the target secondary volume and issues an instruction to the container apparatus 120-1 with the container apparatus name of the target primary volume to copy data from the target primary volume to the target secondary volume.

In step S1102, the container apparatus 120-1 issues a request to the storage apparatus 130-1 with the storage apparatus name, which provides the target primary volume, to read the data of the target primary volume.

In step S1103, the storage apparatus 130-1 reads the data of the target primary volume.

In step S1104, the storage apparatus 130-1 writes (transmits) the data to the container apparatus 120-1 which is a request source.

In step S1105, the container apparatus 120-1 writes (receives) the data.

In step S1106, the container apparatus 120-1 issues a request (transmits) to the container apparatus 120-2 with the container apparatus name of the target secondary volume to write the data.

In step S1107, the container apparatus 120-2 issues a request to the storage apparatus 130-2 with the storage apparatus name, which provides the target secondary volume, to write the data of the target secondary volume.

In step S1108, the storage apparatus 130-2 writes the data of the target secondary volume.

In step S1109, the storage apparatus 130-2 completes writing the data of the target secondary volume.

In step S1110, the storage apparatus 130-2 updates the replication management table 332. More specifically, the storage apparatus 130-2 adds a first record relating to the target primary volume and a second record relating to the target secondary volume to the replication management table 332. For example, the following information is set to the first record: the storage apparatus name linked to the target primary volume in the registry-image management table 304 as the storage apparatus name; the volume name linked to the target primary volume in the registry-image management table 304 as the volume name; the volume capacity of a copy source or a copy destination as the capacity; the “primary volume” as the primary/secondary volume; the “pair” as the replication mode; and the volume name linked to the target secondary volume in the registry-image management table 304 as the pair volume. For example, the following information is set to the second record: the storage apparatus name linked to the target secondary volume in the registry-image management table 304 as the storage apparatus name; the volume name linked to the target secondary volume in the registry-image management table 304 as the volume name; the volume capacity of the copy source or the copy destination as the capacity; the “secondary volume” as the primary/secondary volume; the “pair” as the replication mode; and the volume name linked to the target primary volume in the registry-image management table 304 as the pair volume.

In step S1111, the container apparatus 120-2 transmits a notice (completion notice) to the container apparatus 120-1 to inform it that the data copying has been completed.

In step S1112, the container apparatus 120-1 issues an instruction to the storage apparatus 130-1 with the storage apparatus name, which provides the target primary volume, to update the registry-image management table 304.

In step S1113, the storage apparatus 130-1 updates the replication management table 332. Incidentally, such update is similar to that in step S1110, so that its explanation is omitted.

In step S1114, the storage apparatus 130-1 transmits a notice (completion notice) to the container apparatus 120-1 to inform it that the update of the replication management table 332 has been completed.

In step S1115, the container apparatus 120-1 transmits a notice (completion notice) to the management apparatus 102 to inform it that the setting of the replication has been completed.

In step S1116, the management apparatus 102 receives the completion notice.

### (A-4) Creation of a Copy of the Container Image 112 in the Registry 111 at the Remote Site

FIG. 12 is a diagram illustrating an example of the processing relating to the creation of a copy of the container image 112 in the registry 111 at the remote site.

In step S1201 after receiving the completion notice in step S1116, the management apparatus 102 acquires the information relating to the container image 112-1 (the target container image 112) on which the started container 121 is based. More specifically, the management apparatus 102 acquires the storage apparatus name and the image name which are linked to the target primary volume, and the storage apparatus name linked to the target secondary volume in the record added in step S1009 from the volume-image management table 305.

In step S1202, the management apparatus 102 acquires the site name linked to the storage apparatus name of the target primary volume and the site name linked to the storage apparatus name of the target secondary volume from the site-storage management table 302. In this example, “Site1” is acquired as the site name linked to the storage apparatus name of the target primary volume and “Site2” is acquired as the site name linked to the storage apparatus name of the target secondary volume.

In step S1203, the management apparatus 102 acquires the registry apparatus name and the registry name which are linked to the site name of the target primary volume, and the registry apparatus name and the registry name which are linked to the site name of the target secondary volume from the site-registry management table 303. The registry apparatus name “RegS1” and the registry name “Reg1” which are linked to the site name “Site1” of the target primary volume and the registry apparatus name “RegS2” and the registry name “Reg2” which are linked to the site name “Site2” of the target secondary volume are acquired. Then, the management apparatus 102 issues an instruction to the registry apparatus 110-1 with the registry apparatus name of the acquired target primary volume to copy the target container image 112 to the registry apparatus 110-2 with the registry apparatus name of the acquired target secondary volume. The above-described instruction includes, for example, the registry apparatus name, the registry name, and the image name at the local site and the registry apparatus name and the registry name at the remote site.

In step S1204, the registry apparatus 110-1 reads the container image 112-1 with the acquired image name (the target container image 112) from the registry 111-1 and transmits it to the registry apparatus 110-2 with the registry apparatus name at the remote site.

In step S1205, the registry apparatus 110-2 writes the container image 112-1 as the container image 112-2 to the registry 111-2.

In step S1206, the registry apparatus 110-2 transmits a notice (completion notice) to the client apparatus 103 to inform it that writing has been completed.

In step S1207, the client apparatus 103 receives the completion notice.

Consequently, the processing upon the container startup terminates.

### (B) Processing Upon Container Image Update

FIG. 13 is a diagram illustrating an example of the processing relating to the creation of a copy of the updated container image 112 at the remote site.

In step S1301, the client apparatus 103 executes a command to generate the container 121, which is being used, as a container image 112 with another name (an update command by designating the image name). An explanation will be provided below about an example where the client apparatus 103 executes the update command on the registry apparatus 110-1 which stores the container image 112-1 of the container 121-1.

In step S1302, the registry apparatus 110-1 updates (for example, adds) the container image 112-1.

In step S1303, the registry apparatus 110-1 transmits the image name of the container image 112-1 before the update, its own registry name (the registry name at the local site), and the designated image name to the management apparatus 102. As a result of such transmission, the management apparatus 102 can detect the update of the container image 112.

In step S1304, the management apparatus 102 acquires the registry name at the remote site which is linked to the image name before the update from the registry-image management table 304. Incidentally, the management apparatus 102 may acquire the registry name at the remote site by using the site-storage management table 302, the site-registry management table 303, and the volume-image management table 305.

In step S1305, the management apparatus 102 acquires the site name and the registry apparatus name which are linked to the registry name at the remote site from the site-registry management table 303. In this example, the management apparatus 102 issues an instruction to copy the updated container image 112-1 (target container image) from the registry apparatus 110-1 at the local site to the registry apparatus 110-2 at the remote site. The above-described instruction includes, for example, the site name of the remote site, the registry apparatus name, and the registry name.

Furthermore, the management apparatus 102 updates the management table 102A. More specifically, the management apparatus 102 adds a record to the registry-image management table 304 by using the image name designed by the client apparatus 103 and the registry name at the local site. Furthermore, the management apparatus 102 updates (overwrites) the image name, which is associated with the container 121-1, to (with) the designated image name in the volume-image management table 305.

In step S1306, the registry apparatus 110-1 transmits the target container image to the registry apparatus 110-2 with the registry apparatus name at the remote site.

In step S1307, the registry apparatus 110-2 adds the target container image to the registry 111-2.

In step S1308, the registry apparatus 110-2 transmits a notice (completion notice) to the client apparatus 103 to inform it that the update has been completed.

In step S1309, the client apparatus 103 receives the completion notice.

Consequently, the processing upon the container image update terminates. When the container image 112-1 of the registry apparatus 110-1 is updated as described above, the management apparatus 102 automatically synchronizes the updated container image 112-1 between the local site and the remote site by transmitting the updated container image 112-1 to the registry apparatus 110-2. As a result of the above-described synchronization, it becomes possible to avoid the circumstance incapable of taking out the updated container image 112-1 when the situation takes place where the local site cannot be accessed. However, the configuration in which the administrator manually performs copying (synchronization) is not excluded.

### (C) Processing Upon Failover

FIG. 14 is a diagram illustrating an example of the processing relating to the startup of the container 121 at the remote site.

Step S1401 indicates that a failure has occurred at a specified storage apparatus 130 at the local site (this example will be explained by taking the storage apparatus 130-1 as an example).

In step S1402, the storage apparatus 130-2, regarding which the replication is set with the storage apparatus 130-1 where the failure has occurred, detects the occurrence of the failure at the storage apparatus 130-1.

In step S1403, the storage apparatus 130-2 refers to the replication management table 332-2 and switches the replication mode of the primary volume and the secondary volume which are linked to the storage apparatus name of the storage apparatus 130-1, where the failure has occurred, to the “pair division.”

In step S1404, the storage apparatus 130-2 acquires the storage apparatus name and the volume name of the secondary volume, which has been switched to the “pair division,” from the replication management table 332-2.

In step S1405, the container apparatus 120-2 transmits the storage apparatus name and the volume name of the secondary volume, which have been acquired, to the management apparatus 102.

In step S1406, the management apparatus 102 acquires the container apparatus name, the storage apparatus name, and the image name of the secondary volume from the volume-image management table 305 by using the received volume name as a key.

In step S1407, the management apparatus 102 acquires the site name linked to the acquired storage apparatus name from the site-storage management table 302.

In step S1408, the management apparatus 102 acquires the registry apparatus name and the registry name, which are linked to the acquired site name, from the site-registry management table 303. The management apparatus 102 transmits an instruction to the registry apparatus 110-2 with the acquired registry apparatus name to copy the container image 112-2 with the acquired registry name from the registry apparatus 110-2 with the acquired registry apparatus name to the container apparatus 120-2 with the acquired container apparatus name, start the container 121-2, and attach it to the volume 131-2 with the received volume name. The above-described instruction includes, for example, the acquired registry apparatus name, the registry name, the image name, the container apparatus name, the storage apparatus name, and the received volume name.

In step S1409, the registry apparatus 110-2 reads the container image 112-2 with the received image name on the basis of the received instruction (or transmits it to the container apparatus 120-2 with the received container apparatus name).

In step S1410, the container apparatus 120-2 writes (receives) the read container image 112-2.

In step S1411, the container apparatus 120-2 starts (activates) the container 121-2, attaches (links) the volume 131-2 with the received volume name, and transmits a notice (completion notice) to the client apparatus 103 to inform it that the startup of the container 121-2 has been completed.

In step S1412, the client apparatus 103 receives the completion notice.

Consequently, the processing upon failover terminates. When the storage apparatus 130-2 at the remote site detects a failure (for example, the replication has been broken relating to the volume 131-1 at the local site as described above, the storage apparatus 130-2 transmits the volume name of the volume 131-2 to the management apparatus 102 on the basis of the replication management table 332 (an example of the replication management information) indicating the correspondence relationship between the volume 131-1 and the volume 131-2. Furthermore, the management apparatus 102 identifies the container image 112-2 associated with the volume 131-2 from the management table 102A and transmits an instruction to the container apparatus 120-2 to activate the container 121-2 based on the container image 112-2 and link the container 121-2 to the volume 131-2. According to the above-described configuration, the container 121-2 is started as triggered by the break-up of the replication, so that downtime can be shortened. Furthermore, the startup of the container 121-2 can be automated, so that the administrator's work upon the occurrence of a failure can be reduced.

According to this embodiment, for example, the container image is copied to the registry at an appropriate site, so that necessary data to start the container at the remote site can be migrated with certainty. Furthermore, for example, since the container image is copied to the remote site which is the replication destination, it becomes easier to start the container at the remote site. Furthermore, for example, the container can be started at the remote site without the necessity to manage the correspondence relationship between the secondary volume and the container image by using a register. Accordingly, the container can be activated at the remote site in a short time, thereby making it possible to implement a highly reliably system.

### (2) Second Embodiment

A second embodiment will be explained. When doing so, the difference between the first embodiment and the second embodiment will be mainly explained and any explanation about points in common with the first embodiment will be omitted or simplified.

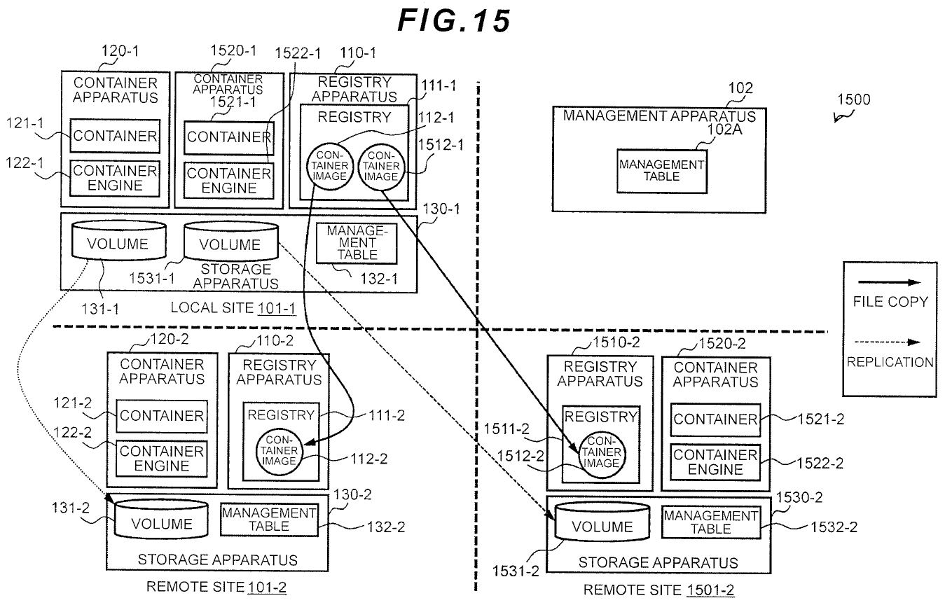

In this embodiment, as illustrated in FIG. 15, a container provision support system 1500 is configured by including the local site (the site 101-1) and a plurality of remote sites (the site 101-2 and a site 1501-2). Incidentally, this embodiment shows the configuration where a plurality of container apparatuses are provided at the local site and the remote sites are provided corresponding to the container apparatuses; however, without limitation to this example, the remote site(s) may be provided corresponding to one or more container apparatuses.

The site 101-1 which is the local site is provided with the container apparatus 120-1 and a container apparatus 1520-1. The container apparatus 1520-1 includes a container engine 1522-1 and activates a container 1521-1 based on a container image 1512-1 stored in the registry apparatus 110-1. The container 1521-1 is linked to a volume 1531-1 (primary volume) and the volume 1531-1 is used in an APP which operates on the container 1521-1.

The site 1501-2 which is the remote site is provided with a registry apparatus 1510-2, a container apparatus 1520-2, and a storage apparatus 1530-2. The registry apparatus 1510 includes a registry 1511-2 and the registry 1511-2 stores a container image 1512-2 which is a copy of the container image 1512-1. Furthermore, the storage apparatus 1530 is provided with a volume 1531-2 (secondary volume) for the replication corresponding to the volume 1531-1 (primary volume) and is equipped with a management table 1532-2. When a failure occurs at, for example, the volume 1531-1 at the local site, a container engine 1522-2 for the container apparatus 1520-2 starts the container 1521-2 based on the container image 1512-2 from the registry 1511-2 and links the volume 1531-2 to the container 1521-2.

The above-described container provision support system 1500 has, for example, the following characteristic configuration. For example, a first registry apparatus (for example, the registry apparatus 110-1) has another container image (for example, the container image 1512-1) different from a first container image (for example, the container image 112-1). A first site (for example, the site 101-1) is provided with another container apparatus (for example, the container apparatus 1520-1) to activate another container (for example, the container 1521-1), which is an environment to execute an application program, on the basis of the above-mentioned other container image. A first storage apparatus (for example, the storage apparatus 130-1) provides another volume (for example, the volume 1531-1) which is different from the first volume used in the above-mentioned application program. A third site (for example, the site 1501-2) which is a site different from the second site (for example, the site 101-2) is provided with a third registry apparatus (for example, the registry apparatus 1510-2) including a third container image (for example, the container image 1512-2) which is replicated data of the above-mentioned other container image, a third container apparatus (for example, the container apparatus 1520-2) to activate a third container (for example, the container 1521-2) based on the above-mentioned third container image, and a third storage apparatus (for example, the storage apparatus 1530-2) that provides a third volume (for example, the volume 1531-2) which is used in an application program executed on the above-mentioned third container and which is replicated data of the above-mentioned other volume. A management unit (for example, the management apparatus 102) manages the management information (for example, the volume-image management table 305) which associates identification information of the above-mentioned other volume (for example, the container apparatus name, the storage apparatus name, and the volume name), identification information of the above-mentioned third volume (for example, the container apparatus name, the storage apparatus name, and the volume name), and identification information of the above-mentioned first container image (for example, the image name) with each other.

In this embodiment, for example, the remote site(s) is/are provided corresponding to the container apparatus(es), so that it is no longer necessary to provide a system of the same scale at the remote site as that of the local site. Furthermore, the remote site(s) can be provided according to the operation (for example, for the container apparatus regarding which the time required to provide the container upon the occurrence of a failure needs to be shortened, from among the container apparatuses at the local site).

### (3) Third Embodiment

A third embodiment will be explained. When doing so, the difference between the first embodiment and the third embodiment will be mainly explained and any explanation about points in common with the first embodiment will be omitted or simplified.

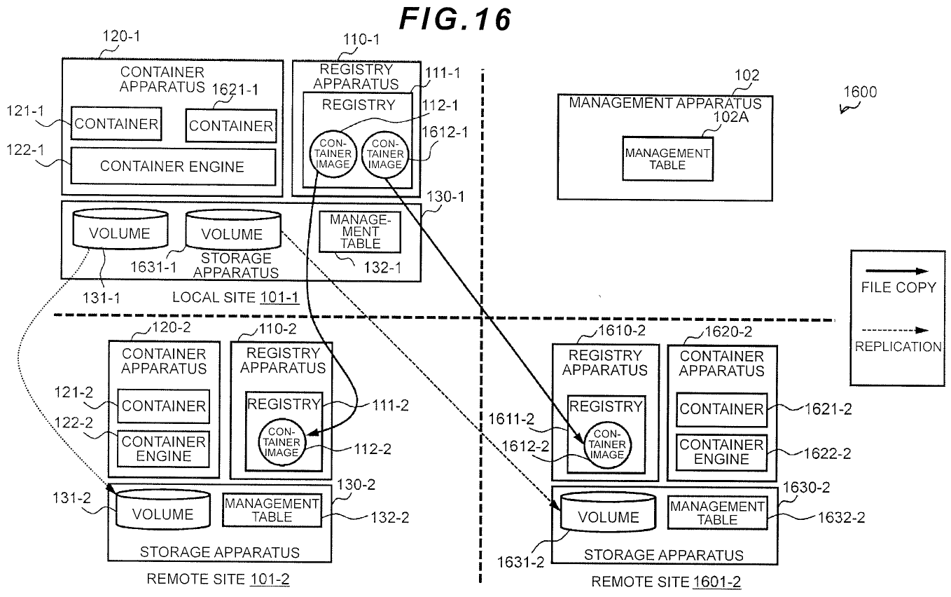

In this embodiment, as illustrated in FIG. 16, a container provision support system 1600 is configured by including the local site (the site 101-1) and a plurality of remote sites (the site 101-2 and a site 1601-2). Incidentally, this embodiment shows the configuration where a plurality of containers are provided at the local site and the remote sites are provided corresponding to the containers; however, without limitation to this example, the remote site(s) may be provided corresponding to one or more containers.

The local site 101-1 is provided with the container apparatus 120-1 and the container apparatus 120-1 activates a container 1621-1 based on a container image 1612-1 stored in the registry apparatus 110-1. The container 1621-1 is linked to a volume 1631-1 (primary volume) and the volume 1631-1 is used in an APP which operates on the container 1621-1.

The site 1601-2 which is the remote site is provided with a registry apparatus 1610-2, a container apparatus 1620-2, and a storage apparatus 1630-2. The registry apparatus 1610 includes a registry 1611-2 and the registry 1611-2 stores a container image 1612-2 which is a copy of the container image 1612-1. Furthermore, the storage apparatus 1630 is provided with a volume 1631-2 (secondary volume) for the replication corresponding to the volume 1631-1 (primary volume) and is equipped with a management table 1632-2. When a failure occurs at, for example, the volume 1631-1 at the local site, a container engine 1622-2 for the container apparatus 1620-2 starts the container 1621-2 based on the container image 1612-2 from the registry 1611-2 and links the volume 1631-2 to the container 1621-2.

The above-described container provision support system 1600 has, for example, the following characteristic configuration. For example, a first registry apparatus (for example, the registry apparatus 110-1) has another container image (for example, the container image 1612-1) different from a first container image (for example, the container image 112-1). A first container apparatus activates another container (for example, the container 1621-1), which is an environment to execute an application program, on the basis of the above-mentioned other container image. A first storage apparatus (for example, the storage apparatus 130-1) provides another volume (for example, the volume 1631-1) which is different from the first volume used in the above-mentioned application program. A third site (for example, the site 1601-2) which is a site different from the second site (for example, the site 101-2) is provided with a third registry apparatus (for example, the registry apparatus 1610-2) including a third container image (for example, the container image 1612-2) which is replicated data of the above-mentioned other container image, a third container apparatus (for example, the container apparatus 1620-2) to activate a third container (for example, the container 1621-2) based on the above-mentioned third container image, and a third storage apparatus (for example, the storage apparatus 1630-2) that provides a third volume (for example, the volume 1631-2) which is used in an application program executed on the above-mentioned third container and which is replicated data of the above-mentioned other volume. A management unit (for example, the management apparatus 102) manages the management information (for example, the volume-image management table 305) which associates identification information of the above-mentioned other volume (for example, the container name, the container apparatus name, the storage apparatus name, and the volume name), identification information of the above-mentioned third volume (for example, the container name, the container apparatus name, the storage apparatus name, and the volume name), and identification information of the above-mentioned first container image (for example, the image name) with each other.

In this embodiment, for example, the remote site(s) is/are provided corresponding to the container(s), so that it is no longer necessary to provide a system of the same scale at the remote site as that of the local site. Furthermore, the remote site(s) can be provided according to the operation (for example, for the container regarding which the time required to provide the container upon the occurrence of a failure needs to be shortened, from among the containers at the local site).

### (4) Other Embodiments

Incidentally, the aforementioned embodiments have described the case where the present invention is applied to the container provision support system; however, the present invention is not limited to this example and can be applied to a wide variety of other systems, apparatuses, methods, and programs.

Furthermore, the aforementioned embodiments have described the case where the management apparatus 102 is provided with the management table 102A; however, the present invention is not limited to this example and another storage device (for example, the storage apparatus 130) may be provided with a part or whole of the management table 102A.

Furthermore, the aforementioned embodiments have described the table structure of the site-registry management table 303 based on the premise that one registry apparatus 110 is provided at one site 101; however, the present invention is not limited to this example and the site-registry management table 303 may employ the table structure based on the premise that a plurality of registry apparatuses 110 are provided at one site 101.

Furthermore, the aforementioned embodiments have described that the image name in the volume-image management table 305 is used in common at the local site and at the remote site; however, the present invention is not limited to this example. If different image names are used at the local site and at the remote site, the volume-image management table 305 may be provided with the image name corresponding to the secondary volume and the image name corresponding to the primary volume. Incidentally, in this case, the image name corresponding to the primary volume may not be provided.

Furthermore, in the aforementioned embodiments, the “interface unit” may be one or more interfaces. The one or more interfaces may be one or more communication interface devices of the same type (for example, the one or more interfaces may be one or more NIC's [Network Interface Card]) or two or more communication devices of different types [for example, an NIC and an HBA [Host Bus Adapter]).

Furthermore, in the aforementioned embodiments, the “memory unit” is one or more memories and may typically be a main storage device(s). At least one memory of the memory unit may be a volatile memory or a nonvolatile memory.

Furthermore, in the aforementioned embodiments, the “PDEV unit” may be one or more PDEV's and may typically be an auxiliary storage device(s). The “PDEV” means a physical storage device(s) (Physical storage DEVice) and is typically a nonvolatile storage device(s) such as an HDD's (Hard Disk Drive(s)) or an SSD's (Solid State Drives).

Furthermore, in the aforementioned embodiment, the “storage unit” is at least one of at least a part of the memory unit and the PDEV unit (typically at least the memory unit).

Furthermore, in the aforementioned embodiments, the “processor unit” is one or more processors. At least one processor is typically a microprocessor like a CPU (Central Processing Unit), but may be a processor of a different type such as a GPU (Graphics Processing Unit). At least one processor may be a single core or a multi-core. At least one processor may be a processor in a broad definition like a hardware circuit for performing a part or whole of processing (for example, an FPGA [Field-Programmable Gate Array] or an ASIC [Application Specific Integrated Circuit]).

Furthermore, the aforementioned embodiments have sometimes explained the processing by referring to the “program” as a subject; and since the program is executed by the processor unit and thereby performs the defined processing by using, for example, the storage unit (such as a memory) and/or the interface unit (such as a communication port), the subject of the processing may be the processor. The processing explained by referring to the program as the subject may be processing executed by the processor unit or an apparatus which has that processor unit. Furthermore, the processor unit may include a hardware circuit for performing a part or whole of the processing (such as an FPGA [Field-Programmable Gate Array] or an ASIC [Application Specific Integrated Circuit]). The program may be installed from a program source to an apparatus like a computer. The program source may be, for example, a recording medium (such as a nontemporary recording medium) which can be read by a program distribution server or a computer. Furthermore, in the above-described explanation, two or more programs may be implemented as one program and one program may be implemented as two or more programs.

Furthermore, in the aforementioned embodiments, the structure of each table is one example and one table may be divided into two or more tables and all or some of the two or more tables may be one table.

Furthermore, in the aforementioned embodiments, various kinds of data have been explained by using XX tables and XX files for explanatory convenience; however, the data structure is not limited to the above examples and may be expressed as, for example, XX information.

Furthermore, in the above-described explanation, information such as programs, tables, files, and so on for implementing the respective functions may be placed in storage devices such as memories, hard disks, and SSD's (Solid State Drives) or recording media such as IC cards, SD cards, and DVD's.

Furthermore, the aforementioned configurations may be changed, rearranged, combined, or omitted as appropriate within the range not exceeding the gist of the present invention.

### REFERENCE SIGNS LIST

100: container provision support system
102: management apparatus
110: registry apparatus
112: container image
120: container apparatus
121: container
130: storage apparatus
131: volume

1. A container provision support system,
wherein a first site is provided with a first registry apparatus including a first container image used to activate a first container that is an environment to execute an application program, a first container apparatus for activating the first container based on the first container image, and a first storage apparatus that provides a first volume to be used in the application program; and
a second site is provided with a second storage apparatus that provides a second volume which is replicated data of the first volume,
the container provision support system comprising a management unit that manages management information which associates identification information of the first volume, identification information of the second volume, and identification information of the first container image with each other.

2. The container provision support system according to claim 1,
wherein after receiving a request from a client apparatus to start the first container by designating the first volume, the management unit:
issues an instruction to the second storage apparatus to create the second volume and acquires the identification information of the second volume created by the second storage apparatus; and
generates the management information by associating the identification information of the first volume designated by the request, the identification information of the second volume which is acquired from the second storage apparatus, and the identification information of the first container image, which is used to activate the first container, with each other.

3. The container provision support system according to claim 2,
wherein the second site is provided with a second registry apparatus including a second container image which is replicated data of the first container image, and a second container apparatus that activates a second container based on the second container image.

4. The container provision support system according to claim 3,
wherein when the second volume is created, the first container image is replicated as the second container image in the second registry apparatus.

5. The container provision support system according to claim 3,
wherein when the first container image is updated, the management unit transmits the updated container image to the second registry apparatus.

6. The container provision support system according to claim 3,
wherein when a failure occurs at the first site, the second container apparatus activates the second container based on the second container image and links the second container to the second volume.

7. The container provision support system according to claim 3,
wherein when the second storage apparatus detects a failure relating to the first volume at the first site, the second storage apparatus transmits the identification information of the second volume to the management unit on the basis of replication management information indicating a correspondence relationship between the first volume and the second volume; and
wherein the management unit identifies the second container image associated with the second volume from the management information and transmits an instruction to the second container apparatus to activate the second container based on the second container image and link the second container to the second volume.

8. The container provision support system according to claim 1,
wherein the first registry apparatus includes another container image different from the first container image;
wherein the first site is provided with another container apparatus that activates another container, which is an environment to execute an application program, on the basis of the other container image;
wherein the first storage apparatus provides another volume which is different from the first volume and is to be used in the application program;
wherein a third site which is a site different from the second site is provided with a third registry apparatus including a third container image which is replicated data of the other container image, a third container apparatus that activates a third container on the basis of the third container image, and a third storage apparatus that is used in an application program executed at the third container and provides a third volume which is replicated data of the other volume; and
wherein the management unit manages management information which associates identification information of the other volume, identification information of the third volume, and the identification information of the first container image with each other.

9. The container provision support system according to claim 1,
wherein the first registry apparatus includes another container image different from the first container image;
wherein the first container apparatus activates another container, which is an environment to execute an application program, on the basis of the other container image;
wherein the first storage apparatus provides another volume which is different from the first volume and is to be used in the application program;
wherein a third site which is a site different from the second site is provided with a third registry apparatus including a third container image which is replicated data of the other container image, a third container apparatus that activates a third container based on the third container image, and a third storage apparatus that is used in an application program executed at the third container and provides a third volume which is replicated data of the other volume; and
wherein the management unit manages management information which associates identification information of the other volume, identification information of the third volume, and the identification information of the first container image with each other.

10. A container provision support method,
wherein a first site is provided with a first registry apparatus including a first container image used to activate a first container that is an environment to execute an application program, a first container apparatus for activating the first container based on the first container image, and a first storage apparatus that provides a first volume to be used in the application program; and
a second site is provided with a second storage apparatus that provides a second volume which is replicated data of the first volume,
the container provision support method comprising:
a first step executed by a management unit receiving a request from a client apparatus to start the first container by designating the first volume;
a second step executed by the management unit issuing an instruction to the second storage apparatus to create the second volume and acquiring identification information of the second volume created by the second storage apparatus; and
a third step executed by the management unit generating management information by associating identification information of the first volume designated by the request, the identification information of the second volume which is acquired from the second storage apparatus, and identification information of the first container image, which is used to activate the first container, with each other.
